(19) United States
(12) Patent Application Publication
(10) Pub. No.: US 2007/0140603 A1
(43) Pub. Date: Jun. 21, 2007

(54) Bearing surface and bearing element

(76) Inventors: Emil Medvetchi, Winterthur (CH); Roland Styner, Illnau (CH); Paul Cahannes, Embrach (CH)

Correspondence Address: DORITY & MANNING, P.A., POST OFFICE BOX 1449, GREENVILLE, SC, 29602-1449, US

(21) Appl. No.: 10/558,986

(22) PCT Filed: Jun. 2, 2004
(86) PCT No.: PCT/CH04/00332

§ 371 Date: Jan. 29, 2007

(30) Foreign Application Priority Data
Jun. 3, 2003 (CH) 0981/03

(51) Int. Cl. F16C 19/00

(52) U.S. Cl. 384/58

(57) ABSTRACT

The invention relates to a bearing surface for the end portions of work elements, which extend across a roller of a textile machine, for example a carding element, a knife, a cover element or a grid rod.

The invention relates to a bearing surface for the end portions of work elements, which extend across a roller of a textile machine, for example a carding element, a knife, and a cover element or grid rod.

Within textile machines trimmed rollers are used in many places. These rollers mostly comprise at least two roller shields or flanges at the front surface, in which, on the one hand, the roller is rotatable mounted and which, on the other hand, can comprise bearing elements for mounting and/or supporting of additional work elements. The work elements have in common that they are somewhat longer than the working width of the roller, and that they rest on the left and on the right on the beating elements, for example segment curve, cover segments or (flexible-) curves, which are partially also adjustable.

These work elements can be divided into two main groups: stationary work elements, which are arranged stationary, for example carding elements, cover elements, knives, grids, or guide elements, and movable work elements which are pulled by an endlessly rotating tape, for example by means of a chain or a belt, across the bearing surface of the bearing elements, for example the flat of a card.

The work elements can have the form of plates or rods and they always have a side, which is arranged opposite the clothing of the roller. The space between this side and the clothing of the roller is adjusted as precisely as possible. This setting affects, depending on the function of the segment, the carding quality amongst other things. In particular with carding segments a narrow gap to the roller increases the carding quality and reduces the number of neps in the final product as well as the dirt separation.

An optimal setting is achieved when the desired distance is equal across the whole width. Since these settings lie within the range of tenth of millimetres, deviations of one hundredth of a millimetre can already have a substantial effect on the function of the individual segments.

The EP 790 338 describes an adjusting device at a card, whereby adjustable bearing elements in the form of a curve are attached to the drum shields. These bearing elements are the bases for the different stationary work elements which are arranged across the working width of the roller and which are attached with a simple screw connection. The different stationary work elements can be adjusted altogether in one step by means of the adjusting screws of the bearing elements for the setting of the space between the work elements and the clothing of the roller. (See in EP 790 338 FIGS. 7 to 10 and the pertaining description).

The stationary work elements have at their end portions flat, straight zones for mounting, which can rest on the straight bearing surfaces of the bearing element. In addition to the simple screw connection there is a spring stack provided between the head of the screw and its opposite surface of the end portion of the stationary work element. By means of the spring stack the contact pressure between the work element and the bottom side of the end portion (in particular in the proximity of the screw) becomes limited. Thereby the work element is permitted to expand itself in its longitudinal direction during operation (i.e. towards the working width of the machine). This possibility of expansion must be given, because the card heats itself up during operation and thus all components expand.

This adjusting device has the disadvantage that if, with the screw connection of the individual stationary work elements on the bearing element, the accurate position is not achieved, this has an effect on the carding gap (distance between roller and work element) and thus on the carding quality. The production of the components requires therefore high precision, with a small tolerance range. The optimal setting of the space is only possible if the bearing surface lies on one level and parallel to the outer surface of the roller on both sides. In case of small deviations of the bearing elements, for example with an inclination, whereby the bearing surface is arranged somewhat outward tilted, this can have the consequence, that the stationary work element is being pulled into a hollow state—i.e. being curved. Thus an unequal space results across the working width of the roller, with a broader gap in the centre zone and a narrower gap in the edge zone of the work element. A reverse effect can occur if the bearing elements are furnished in inward tilted manner. The work element can, during mounting, be pulled in such a way that it takes on a bellied shape. Thereby a rather broad gap results in the boundary zone and a narrower gap in the centre of the work element.

These effects play less a role for commercially normal cards with a working width of 1 meter. With the new generation of high performance cards, e.g. the C-60 card of Rieter, the working width, however, is larger than 1 meter, for example 1,5 meters. The deviation, which results from the above-mentioned type of mounting, cannot be neglected, but results in a problem for the overall carding quality of the card.

The pressure of the endless tape on the flats of a revolving flat card is comparable with the pressure of the mounting screw of a stationary work element. This force can also, in connection with an inclination of the bearing surface, exercise an unwanted effect on the carding gap.

It is the task of the invention to provide a device of the initially described kind which avoids the disadvantages mentioned, which, in particular, arranges the bearing point between the work element and the bearing element in such a way, that a force on the bearing point of the work element reduces or eliminates the unwanted effect on the space to be adjusted between the clothing of the roller and the side of the work element opposite the roller, across the total working width of the roller.

The solution of this task is given with the characteristic features of claim 1.

By adapting the bearing surface in its cross section, a lever effect which results during an inclination of the bearing surface, can be reduced or even be eliminated, in particular by reducing the bearing surface, preferably by slanting the edge in the cross section. The solution mostly preferred is provided in such a way that the bearing surface comprises a curved cross section. Both solutions are described in more detail by way of the figures of exemplified embodiments. Although the examples refer to a card, in particular to the drum roller, the invention is generally applicable with rollers in the blow room and card room with the arrangement of stationary or moving work elements of the initially described kind. There is shown in:

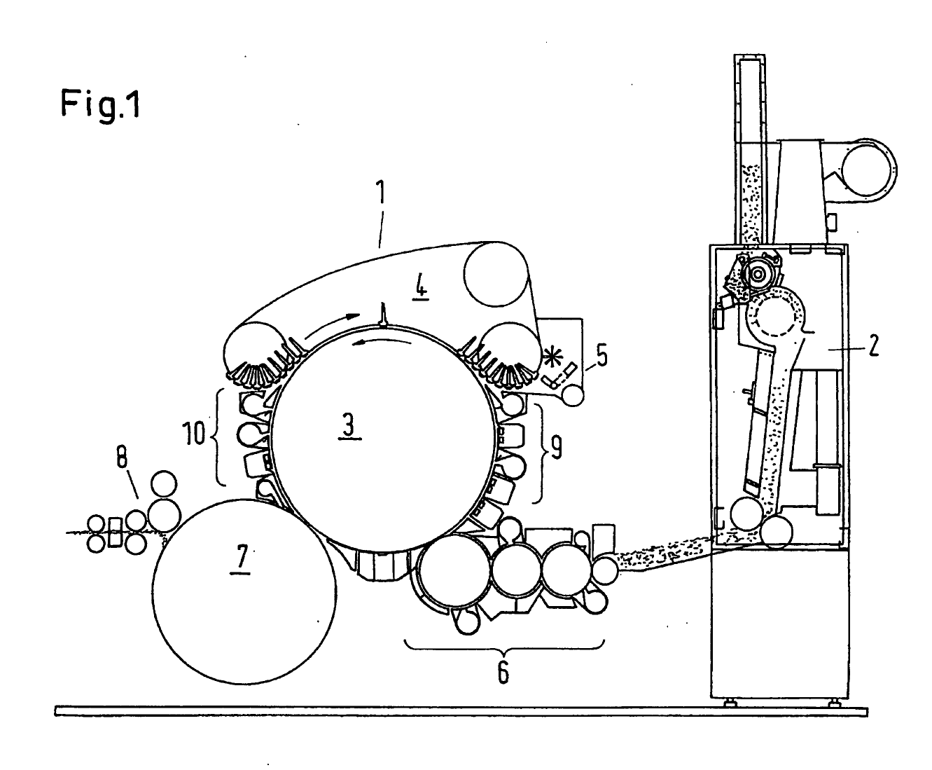

FIG. 1 a schematic side view of a card;

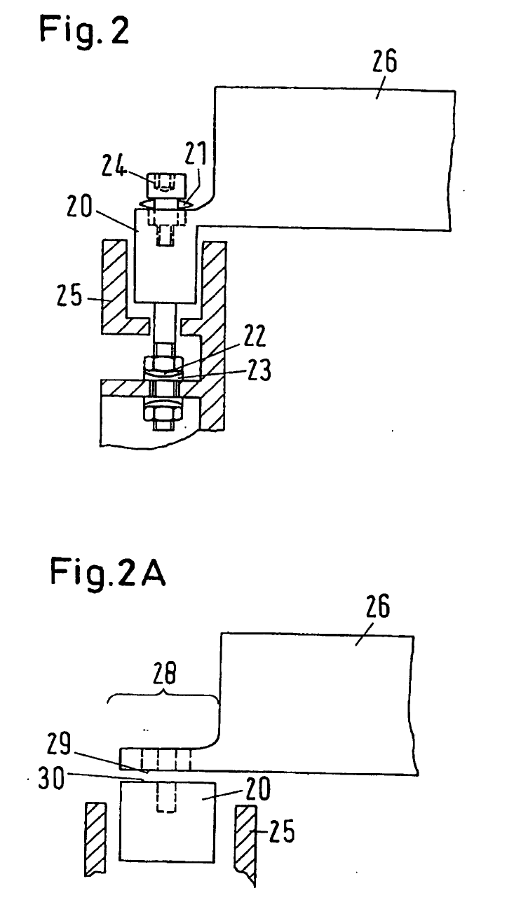

FIGS. 2, 2A schematic illustrations of the mounting device of a stationary work element with the bearing element in cross section;

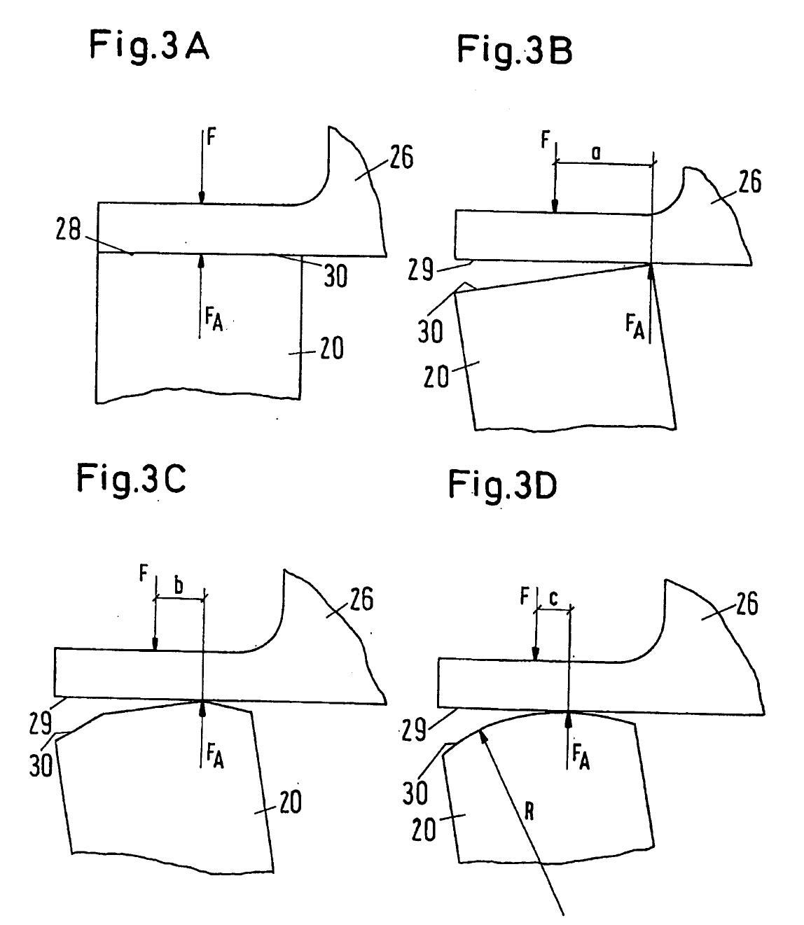

FIG. 3A an ideal connection with the bearing element in the cross section;

FIG. 3B a connecting position at inclination of the drum segment;

FIG. 3C a solution according to the invention with the bearing element in cross section;

FIG. 3D a preferred embodiment according to the invention with the bearing element in cross section.

FIG. 1 shows a revolving flat card, e.g. the Rieter card C60 with a working width of 1.5 meters, with a filling chute 1. Fibre flakes are transported through the different cleaning process stages by way of transportation channels (not shown) and finally supplied into the filling chute of the card. This chute then further supplies the fibre flakes to the card in the form of cotton wool. The feed roller 3 and feeding trough 4 together feed the fibre flakes to the taker-in 5a, 5b and 5c. The taker-in opens the fibre flakes and removes part of the dirt particles. The final taker-in roller 5c transfers the fibre to the card drum 6. The card drum 6 co-operates with the flats 7 and thereby still further parallelizes the fibres. After the fibres have partially performed several circulations on the card drum 6, they are taken-off from the card drum 6 by receiver roller 8, supplied to the squeezing roller 9 and finally deposited as lap 10 in a can (not shown).

Stationary work elements can in principle be arranged to any roller of the card. In particular the taker-in 5a, 5b and 5c and the drum 6 are very often furnished with cleaning components such as knives 18, or carding elements 17. The accurate number of the work elements and their arrangement can vary from card to card. Basically, however, the rollers are completely covered so that no fibres, dirt and dust can exit. At the transfer point from roller to roller guide elements can be applied. But also at the rollers within the filling chute stationary work elements can be arranged, for example the EP 787841 discloses cleaning components which are assigned to the dissolving part. Also individual knives or grid rods can be assigned to cleaning rollers in other blow room machines such as coarse or fine cleaners.

The drum 6 can be divided into four subsections. The pre-carding zone 12, the main carding zone 13, the re-carding zone 14 and the sub-carding zone 15. In a revolving flat card the revolving flat 11 makes up the main carding zone 13, while the pre-carding zone, the re-carding zone and the sub-carding zone are mostly equipped with stationary work elements. There are, however, also cards which do not have a revolving flat, instead there then are stationary work elements within the main carding zone. These stationary work elements can be covering elements or casing elements 16, carding elements 17, knives possibly with a suction device 18, or guide elements 19. The mounting device according to the invention can generally be applied in the various stationary work elements.

The stationary work elements extend across the working width of the drum and have identical mounting devices at both end portions. In FIG. 2 the mounting device of an end portion is schematically illustrated, seen across the working width of the card. In FIG. 2A a part of the device is drawn once again, whereby the different surfaces are shown more clearly. The end portion 28 can be designed differently. Significant for the mounting device according to the invention is the bearing surface 29. Preferably the bearing surfaces of the work element 29 and that of the bearing element 30 lie opposite each other. Preferably, a combination of convex and concave spherical washers can minimize, though, not completely eliminate a possible inclination of the bearing element during the mounting of the bearing element on the drum shield. An inclination can for example result due to finishing errors during production or when tightening during the assembly.

FIG. 3 illustrates, strongly simplified, the forces, which act on both bearing surfaces (only the bearing element and the end of the work element are illustrated). FIG. 3A shows the ideal support—both bearing surfaces 29 and 30 are on the same level; respectively the forces F and F_{A} lie on the same straining line (line of action). No lever effect arises; the work element is not deformed.

FIG. 3B shows an exaggerated inclination of the bearing element. Since the forces do not lie on the same straining line, a lever effect results therefore from the force of the work element onto the bearing element, which deforms the work element (hollow or bellied).

FIG. 3C shows a first solution according to the invention. The edges of the bearing element slanted across the entire curve. By this slanting the bearing point is shifted, which represents the fulcrum for the lever effect, closer to the point, where the force F affects the work element or the gap between the straining lines becomes smaller, i.e. a lower moment is actuated. Thereby, the undesired lever effect is reduced. By the slanting the effective bearing surface is also reduced. In order to achieve a balance between the two forces F and F_{A}, a pointed bearing point would be the ideal solution. The disadvantage of this solution is that there is only one bearing point, which, in consequence, can result in a hollow or a bellied shape of the work element. Since the bearing point is fixedly arranged, even with a small inclination of the bearing element there is no improvement.

A bearing surface according to the invention preferably provides for, that the bearing surface of the bearing element is being bomb shaped—so to speak that it comprises a curved cross section—as is schematically illustrated in FIG. 3D. Each point on the radius R can serve as bearing point. Thereby an improvement—so to speak a reduction—of the inclination, will also result in a reduced lever effect. The rounded off surface has furthermore the advantage that the thermal expansion of the work elements in working direction of the roller cannot be blocked. In particular if the radius. R of the bearing surface is reduced, then the bearing surface gets rounder and the lever effects to be expected will thereby lie within a still more reduced range.

This solution has the consequence that the maximum deformation (hollow or bellied) of the work elements is less large than with the previous type of mounting device that comprises a flat surface. Thereby the possible deviation across the entire gap becomes smaller.

### REFERENCE LIST OF NUMERALS

1. filling chute
2. dissolving place
3. feeding trough
4. feeding roller
5. a, b, c, taker-in
6. drum
7. flat rod
8. doffer roller
9. squeezing roller
10. fibre web
11. revolving flat device
12. pre-carding zone
13. main carding zone
14. re-carding zone
15. sub-carding zone
16. cover element or casing element
17. carding element
18. knife. possibly with suction device
19. guide element
20. bearing element
21. spring stack or tensioning washers
22. spherical convex washer
23. spherical concave washer
24. fastening screw
25. roller shield or roller flange
26. (stationary) work element
27. end portion of the work element
28. bearing surface of the work element
29. bearing surface of the work element
a, b, c moment or leverage effect
F fastening force
F_{A} force on bearing surface.

1. Bearing element for the end portions of work elements, which extend across a roller of a textile machine, whereby the bearing surface is arranged in the area of the end face of the roller, characterized in that the bearing surface comprises a curved upper surface in its cross section.

2-10. (canceled)
